(19) United States
(12) Patent Application Publication
(10) Pub. No.: US 2021/0078193 A1
(43) Pub. Date: Mar. 18, 2021

(54) FILM CUTTING DEVICE HAVING A LINEAR ACTUATOR

(71) Applicant: Dow Global Technologies LLC, Midland, MI (US)

(72) Inventors: Donald L. McCarty, II, Midland, MI (US); William E. Gee, Collegeville, PA (US); Larry Dotson, Midland, MI (US); Paul OConnell, Lake Jackson, TX (US); Jonathan J. Zieman, Midland, MI (US); John Lund, Midland, MI (US)

(73) Assignee: Dow Global Technologies LLC, Midland, MI (US)

(21) Appl. No.: 16/630,726

(22) PCT Filed: Apr. 30, 2018
(86) PCT No.: PCT/US2018/030253

§ 371 Date: Jan. 13, 2020

Related U.S. Application Data
(60) Provisional application No. 62/539,252, filed on Jul. 31, 2017.

(51) Int. Cl. B26D 7/01; B26D 1/04

(52) U.S. Cl. CPC B26D 7/018; B26D 2007/0043; B26D 1/045

(57) ABSTRACT

A method for cutting a film of material and a cutting device for cutting the film of material are described herein. The cutting device includes a film support plate, and a pressure plate configured to move relative to the film support plate to hold the film of material on the film support plate. The device further includes one or more blades, and a linear actuator configured to move the one or more blades relative to the film support plate to cut the film of material held on the film support plate.

### FIELD

The present invention relates to film cutting devices, and in particular to film cutting devices incorporating one or more linear actuators.

### INTRODUCTION

Cutting large sections of film into smaller sizes is often needed in order to facilitate testing of films (e.g., polymeric film or plastic film such as polyethylene film). For example, for testing tensile properties of film, it may be necessary to cut a 6″ (15.24 cm) square of the film into six 1″ (2.54 cm) wide by 6″ (15.24 cm) long strips. As another example, for testing tear properties of film, it may be necessary to cut a 6″ (15.24 cm) square of film into four 3″ (7.62 cm) squares.

There are several methods, techniques and tools for cutting a film of material. The most common way for cutting a film of material is by shear slitting using a pair of shears. For example, top and bottom knives are fixed, and the film is drawn through the knives. In this configuration, the film is cut parallel to the direction of the film travel. Another way of cutting a film is by employing a guillotine style cutter. In this case, the film is cut perpendicular to the direction of travel. The guillotine blade is mounted at an angle with the effect that a leading edge of the blade moves across the film as the blade is lowered.

Another technique for cutting a film is by using a round sharp edged roller or a razor blade. The film is drawn through the round sharp edged roller or through the razor blade. Another way of cutting a film is by crush cutting. In this case, a cutting blade pinches the film against a hardened surface with enough force to cut the film. This technique often leaves a jagged edge, and is very similar to die cutting. In a related version of this cutting method, the film is squeezed between two rollers, and one of the rollers has one or more knives embedded therein. If the knife is wide enough, the film is cut into sections as the film is fed. Often the rollers have embedded knives that cut patterns into the film as it moves between the rollers. The pattern is cut from the middle of the film leaving film attached on both edges. The punched pattern is either separated immediately or drawn into another machine for separation and stacking.

Die cutters are another example of crush cutting. This method is often used in laboratories to obtain molded plastic specimens. However, high pressure press die technology used in film testing is performed by human operators, and is not designed to be automated. For example, the presses do not open wide enough for access by a robotic hand. Additionally, the cut film is not secured after cutting and the film may move, so retrieval of the cut film by automated equipment can be difficult. Further, the cut film often sticks in the die, requiring a user to pick the specimen out of the die. In addition, because of the high pressure requirements, the presses are large devices requiring several square feet of laboratory space. Press dies are also not recommended for tests requiring a non-jagged edge, such as ASTM D882 tensile testing.

The above conventional cutting devices are static devices in that the cutting device is fixed and the film moves relative to the cutting device. The cutting device is generally placed in a manner that the film is drawn into the sharp edge of the cutter blade. All the above conventional cutting devices and associated techniques either produce a jagged edge, require that the film be moved in a web relative to the cutting blade, produce a cut film that is not secured after cutting making retrieval of the cut film difficult, or produce a cut film that sticks to the cutting die requiring a user to retrieve the cut film.

Therefore, a need remains for a film cutting device that solves the above and other problems of existing film cutting devices.

### SUMMARY

It was determined that by using the film cutting device having one or more linear actuators according to an embodiment of the present disclosure, a cut film with a non-jagged edge can be produced. Furthermore, the present film cutting device according to an embodiment of the present disclosure allows cutting a film of material in a plurality of directions. These and other benefits of the film cutting device will be further appreciated in the following paragraphs.

According to an aspect of the present disclosure there is provided a cutting device for cutting a film of material. The cutting device includes a film support plate, and a pressure plate configured to move relative to the film support plate to hold the film of material on the film support plate. The device further includes one or more blades, and a linear actuator configured to move the one or more blades relative to the film support plate to cut the film of material held on the film support plate.

Another aspect of the present disclosure is to provide a method for cutting a film of material. The method includes placing a film of material on a film support plate; moving a pressure plate relative to the film support plate to hold the film of material on the film support plate; and moving one or more blades relative to the film support plate with a linear actuator to cut the film of material held on the film support plate.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 depicts a three-dimensional perspective view of a cutting device, according to an embodiment of the present disclosure;

FIG. 2 is an enlarged, three-dimensional view of a portion of the cutting device of FIG. 1, showing details of the film support plate and pressure plate, according to an embodiment of the present disclosure;

FIGS. 3A and 3B are transverse views showing the positioning of the film of material when held between an extending portion of the pressure plate and the film support plate, according to an embodiment of the present disclosure;

FIGS. 4A and 4B depict examples of cutting blades that can be used as a blade, according to embodiments of the present disclosure;

FIG. 5 is an exploded three-dimensional perspective view of the cutting device, according to an embodiment of the present disclosure;

FIG. 6 is a three-dimensional perspective view showing details of the attachment of the blade to the linear actuator, according to an embodiment of the present disclosure;

FIG. 7 shows schematically a configuration in which a rectilinear shaped film sample is cut into a plurality of strip-shaped specimens, according to an embodiment of the present disclosure;

FIG. 8 is a three-dimensional perspective view of a cutting device, according to another embodiment of the present disclosure;

FIG. 9 is an exploded perspective view of parts of the cutting device showing a plurality of the blades mounted to the linear actuator, according to an embodiment of the present disclosure;

FIG. 10 is a three-dimensional perspective view of the cutting device showing a close-up of the pressure plate and the film support plate, according to an embodiment of the present disclosure;

FIG. 11 is a three-dimensional perspective view of a portion of the cutting device showing details of the film support plate, according to an embodiment of the present disclosure;

FIG. 12 is a three-dimensional perspective view of a portion of the cutting device showing details of the vacuum cups in the cavity of film support plate, according to an embodiment of the present disclosure;

FIGS. 13A and 13B are three-dimensional perspective views showing the positioning and securing of the plurality of blades to the linear actuator, according to an embodiment of the present disclosure;

FIG. 14 shows schematically a configuration in which a square-shaped film sample is cut into a plurality of square-shaped specimens, according to an embodiment of the present disclosure;

FIG. 15 is a three-dimensional perspective view of a cutting device, according to another embodiment of the present disclosure;

FIG. 16 is a three-dimensional perspective view of an arrangement of two linear actuators of FIG. 15 having two blades mounted thereon, according to an embodiment of the present disclosure;

FIG. 17 is a three-dimensional perspective view of the film support plate having a plurality of grooves, and a pressure plate having a corresponding plurality of tongues, according to an embodiment of the present disclosure;

FIG. 18 is a three-dimensional perspective view of the pressure plate of FIG. 17, according to an embodiment of the present disclosure;

FIG. 19 is a three-dimensional perspective view of the pressure plate of FIG. 17 showing a plurality of elbow fittings for providing vacuum to the vacuum cups, according to an embodiment of the present disclosure;

FIG. 20 depicts a cutting configuration, according to yet another embodiment of the present disclosure;

FIGS. 21A and 21B are three-dimensional perspective views showing film support plate and pressure plate in mated and unmated positions, respectively, according to an embodiment of the present disclosure; and

FIG. 22 is a three-dimensional perspective view of a cutting device, according to another embodiment of the present disclosure.

### DETAILED DESCRIPTION

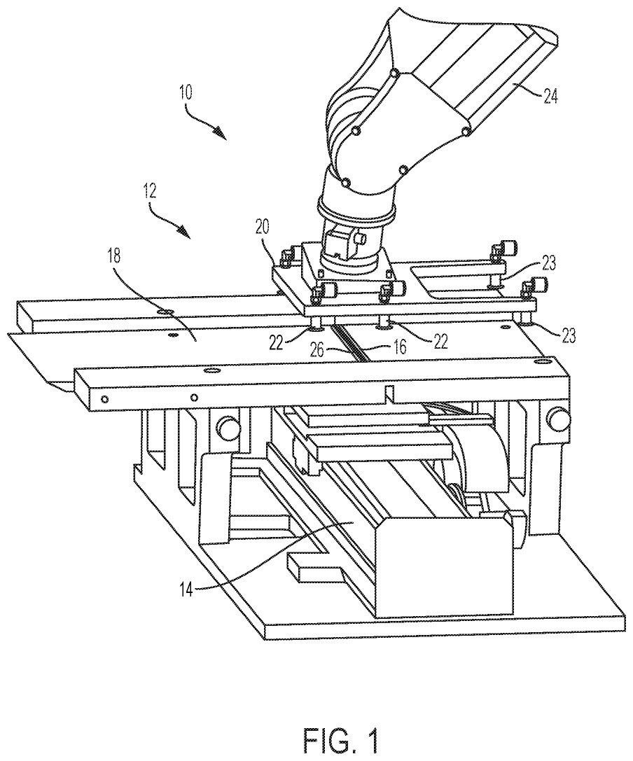

FIG. 1 depicts a three-dimensional perspective view of a cutting device, according to an embodiment of the present disclosure. The cutting device 10 comprises a film holder 12 configured to hold a film of material taut before cutting the film of material, and a linear actuator 14 that drives one or more blades 16. In an embodiment, the film of material may include a polymeric film or plastic film such as a polyethylene film, or non-polymeric films such as paper, fabric, etc., or a composite film of more than one layer of material. According to the embodiment shown, the linear actuator 14 comprises a linear motor having blade 16 mounted to the output of the linear motor 14, however, other embodiments are possible. The linear actuator 14 is configured to move the blade 16 relative to the film of material that is held fixed by the film holder 12, in order to cut the film of material. In an embodiment, the film holder 12 includes a film support plate 18 (e.g., tray) and a pressure plate 20. The film support plate 18 is configured to receive the film of material. In an embodiment, the film support plate 18 is configured to hold the film of material flat. The pressure plate 20 includes a plurality of suction cups 22 to hold the film of material on the film support plate 18. In an embodiment, the pressure plate 20 is mounted on a robotic arm 24 configured to move the pressure plate 20 in various directions. In an embodiment, the robotic arm 24 is a 6-Axis articulated arm robot (e.g., Epson Robotics C8 robot). In another embodiment, the 6-axis robotic arm 24 can be replaced by a robotic arm mounted on moveable wheels or treads. As will be described further below, the robotic arm 24 is configured to provide pressure to hold the film of material in position on the film support plate 18 while the film is cut. For example, the robotic arm can push the pressure plate 20 toward the film support plate 18.

In an embodiment, the robotic arm 24 is further configured to place the film on the film support plate 18 prior to cutting, and to collect portions of the film from the film support plate 18 after cutting. Although the robotic arm 24 is used in one embodiment to provide pressure to hold the film, other types of mechanisms can also be used to provide pressure to hold the film.

In an embodiment, the pressure plate 20 is provided with suction cups arranged to hold the film, e.g., for a polygonal film, at each corner. For example, for a rectilinear film sample, the pressure plate can include two pairs of suction cups 22. The suctions cups 22 can be arranged to hold the film on each corner. In an embodiment, the pressure plate 20 is further provided with a third pair of suction cups 23. The third pair of suction cups 23 can be used to remove cut portions of the film of material from the film support plate 18, for example, for transport to testing equipment such as an optical analyzer, thickness measurement device, tear strength tester, or tensile tester.

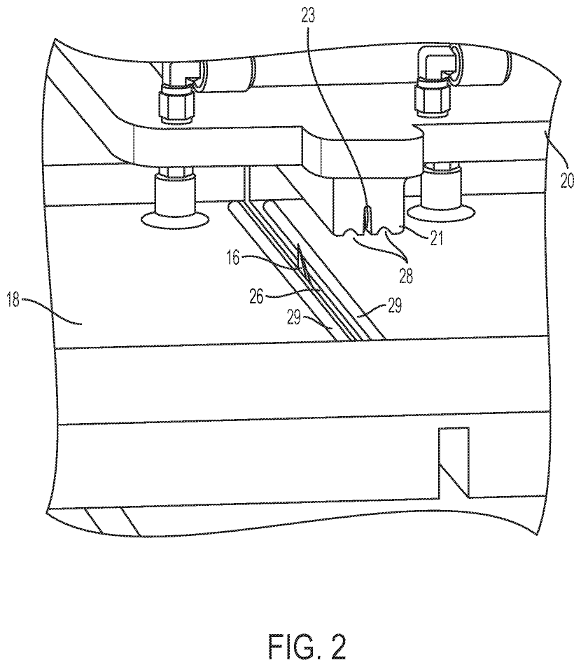

FIG. 2 is an enlarged, three-dimensional view of a portion of the cutting device 10, showing details of the film support plate 18 and pressure plate 20, according to an embodiment of the present disclosure. As shown in both FIG. 1 and FIG. 2, the film support plate 18 includes a slot 26 through which at least a portion of the cutting blade 16 protrudes. In an embodiment, as shown more clearly in FIG. 2, the pressure plate 20 includes an extending portion 21. The extending portion 21 has a plurality of grooves 28 and an opening 23 provided between the grooves 28. The film support plate 18 has tongues 29 defined therein, on opposite sides of the slot 26. The tongues 29 defined in the film support plate 18 are configured to mate with the grooves 28 in the extending portion 21 of the pressure plate 20 when the extending portion 21 is moved into contact with the film support plate 18. The opening 23 in the extending portion 21 of the pressure plate 20 is configured to receive the portion of the blade 16 that protrudes through the slot 26 in the film support plate 18 when the extending portion 21 of the pressure plate 20 is moved into contact with the film support plate 18. The tongues 29 and grooves 28, when mated, are configured to hold the film of material taut. Although FIG. 2 shows the grooves 28 provided on the extending portion 21 of the pressure plate 20 and the tongues 29 provided on the film support plate 18, it is also contemplated that the grooves 28 can be provided on the film support plate 18 and the tongues can be provided on the pressure plate 20.

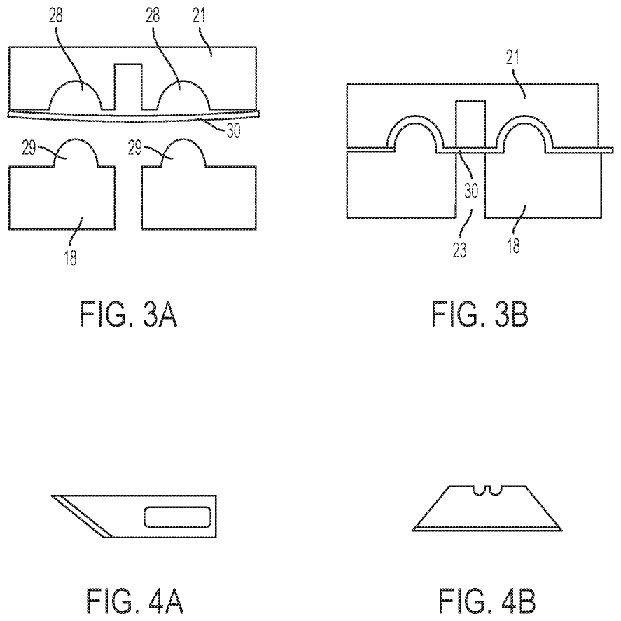

FIGS. 3A and 3B are transverse views showing the positioning of the film of material when held between the extending portion 21 of the pressure plate 20 and the film support plate 18, according to an embodiment of the present disclosure. FIG. 3A depicts the film 30 positioned between the extending portion 21 and the film support plate 18, while the extending portion 21 is spaced apart from the film support plate 18. FIG. 3B depicts the film 30 clamped between the extending portion 21 and the film support plate 18. As can be seen, the tongues 29 press the film 30 into the mating grooves 28, applying a tensioning force to the film 30. According to an embodiment, the dimensions (e.g., radius) of the grooves 28 are not the same as the dimensions (e.g., radius) of the tongues 29. Instead, the tongues 29 can have a slightly smaller radius than the grooves 28, so as to reserve space for the film 30 to be inserted therebetween, as shown in FIG. 3B. The difference in size between the grooves 28 and the tongues 29 can be selected by the user depending, for example, on the thickness of the film 30 to be cut. For example, the size of the grooves 28 and tongues 29 can be selected to accommodate a range of thicknesses of film, e.g., between 0.5 mil (12.7 micrometer) and 10 mil (254 micrometer). Although the grooves 28 and tongues 29 are shown having a semicircular cross-section, the grooves 28 and tongues 29 can also have other mating or substantially mating configurations, such as a polygonal cross-section or other curved or rounded cross-section.

When the film 30 is pushed into the grooves 28 by the tongues 29, the film becomes taut at least in the region spanning the slot 26 in film support plate 18. Accordingly, the blade 16 can run across the film (perpendicular to the plane of FIG. 3B, into the paper) to cut the film in the region spanning the slot 26. According to an alternative embodiment, the blade 16 can run through another space that is not between the pair of mating tongues 29 and grooves 28. In this alternative embodiment, the tongues 29 and grooves 28 can still serve to hold the film 30 taut, for example, on the edges, as the blade 16 traverses the length of the film, as will be described in detail herein below.

In an embodiment, the radius of the groove 28 is slightly larger than the radius of the corresponding tongue 29 by about 0.75 mil (19.05 micrometer). In an embodiment, the slot 26 and the opening 23 (the spaces reserved for the cutting blade 16) have a width of about 0.050 inch (1.27 mm). In an embodiment, the cutting blade has a thickness of 0.020 inch (0.508 mm). Therefore, there can be provided 0.015 inches (0.381 mm) of clearance on each side of the blade 30. According to an embodiment, this is sufficient to allow the blade to run inside the opening 23 and slot 26 without contacting the walls of either the opening 23 or the slot 26.

Referring to FIGS. 4A and 4B, the blade 16 can have various configurations. FIGS. 4A and 4B depict examples of cutting blades that can be used as blade 16, according to embodiments of the present disclosure. In an embodiment, the cutting blade comprises one or more razor blades. For example, the cutting blade shown in FIG. 4A has an angled edge. This angled edge can further facilitate cutting through the film of material. In addition, the blade can be oriented at any angle to provide the desired cutting angle. Another type of cutting blade that can be used as blade 16 is shown in FIG. 4B. The cutting blade in FIG. 4B is a double edged blade. With the blade shown in FIG. 4B, one cutting edge can be used until it becomes dull, and then the cutting blade can be rotated to use the other, fresh cutting edge. One of ordinary skill in the art will understand based on this disclosure that other types or configurations of blades can also be used. In an embodiment, the cutting blade used is similar to the cutting blade shown in FIG. 4A. According to an embodiment, the cutting blade 16 is Part #SS-1C, 7/16″ (11.1125 mm)×1⅞″ (47.625 mm) Tru-Kote, 0.020″ (0.508 mm) thick, closed end, 0.185″×0.790″ (4.699 mm×20.066 mm) slot size, notched blade from Pearl Technologies, Savannah, N.Y.

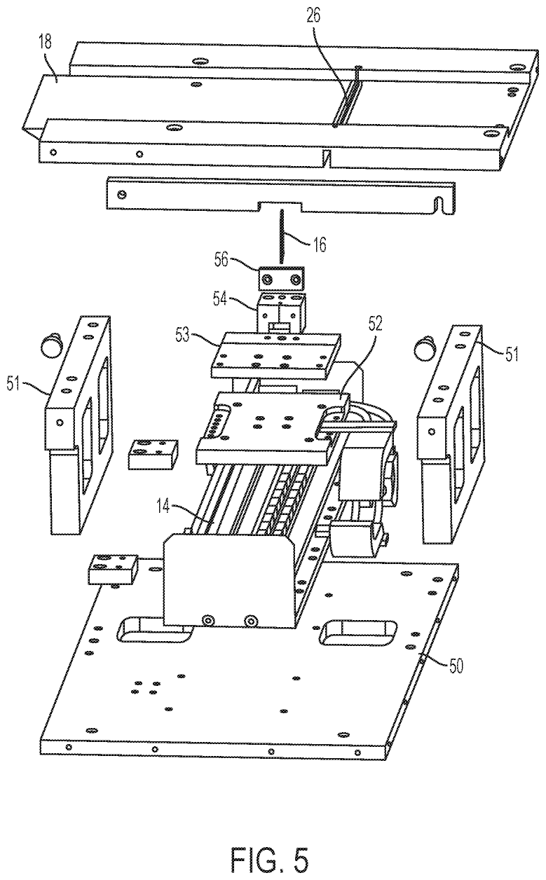

FIG. 5 is an exploded three-dimensional perspective view of the cutting device 10, according to an embodiment of the present disclosure. FIG. 5 depicts the linear actuator 14, according to an embodiment of the present disclosure.

In an embodiment, the linear actuator 14 is a linear motor manufactured by Aerotech Corporation from Pittsburgh, Pa. In another embodiment, the linear actuator 14 is a linear motor manufactured by ETEL Corporation. In an embodiment, the linear actuator 14 is mounted to a base support 50. A movable plate 52 is attached or coupled to output of the linear actuator 14. A blade mounting bracket 54 is mounted to the moveable plate 52 using adjustable plate 53. The adjustable plate 53 is configured to adjust the position of the blade mounting bracket 54 relative moveable plate 52. For example, the blade mounting bracket 54 can be mounted to the position adjustable plate 53 and the position adjustable plate 53 can be mounted to the moveable plate 52 so as to allow the blade mounting bracket 54 and thus the blade 16 to extend forward from an edge of the linear actuator 14. The blade mounting bracket 54 is configured and arranged to receive blade 16. A securing bracket 56 attaches to blade mounting bracket 54 to secure the blade 16 thereto. When the moveable plate 52 is driven by the linear actuator 14, the blade 16 moves along with the moveable plate 52. One of ordinary skill in the art will appreciate that other structures can be implemented to directly or indirectly connect the blade 16 to the linear actuator 14 to be driven thereby. In an embodiment, the film support plate 18 is amounted to the base support 50 using mounting structures 51. The film support plate 18 is mounted to the base support 50 and arranged so that at least a portion of the blade 16 extends through the slot 26.

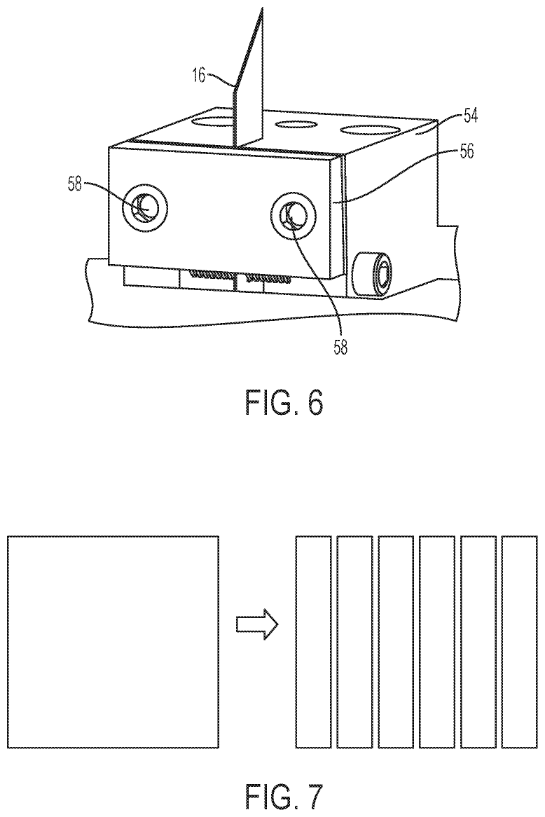

FIG. 6 is a three-dimensional perspective view showing details of the attachment of the blade 16 to the linear actuator, according to an embodiment of the present disclosure. In the embodiment shown, the blade 16 is mounted to the blade mounting bracket 54. The blade mounting bracket 54 has a slot configured to receive the blade 16. The securing bracket 56 is attached to the blade mounting bracket 54, for example, using fasteners 58, to secure the blade 16.

In the above embodiments, a single blade 16 is shown used to cut the film of material. However, according to other embodiments, a plurality of blades can be used to cut the film of material into a plurality of strips.

FIG. 7 shows schematically a configuration in which a rectilinear shaped film of material is cut into a plurality of strips, according to an embodiment of the present disclosure. For example, a 6″ (15.24 cm) square film sample can be cut into six individual film specimens, such as strips 1″ wide (2.54 cm) by 6″ (15.24 cm) long. In this case, for example, 5 blades can be used to slice the film sample into the 6 film specimens. The 1″ (2.54 cm) wide strips can then be pulled out of the device with a vacuum cup gripper or pressure plate attached to a robotic arm.

Although six strips are depicted as being cut from a square-shaped film, any number of specimens can be cut from any shaped film sample. For example, the cutting device can be arranged to cut the film sample once down the middle to create two specimens each 3″ (7.62 cm) by 6″ (15.24 cm), or cut the film sample into 12 specimens, each 0.5″ (1.27 cm) wide by 6″ (15.24 cm) long, etc. A lower limit of the width of the specimens may depend on the type of film being cut. For example, a more rigid film could withstand being cut into narrower strips than could a lesser rigid film. Furthermore, any film size or shape can also be cut. For example, film sample having a shape other than a square or a film sample having dimensions smaller or greater than 6″ (15.24 cm) can be also be cut using the cutting device described herein.

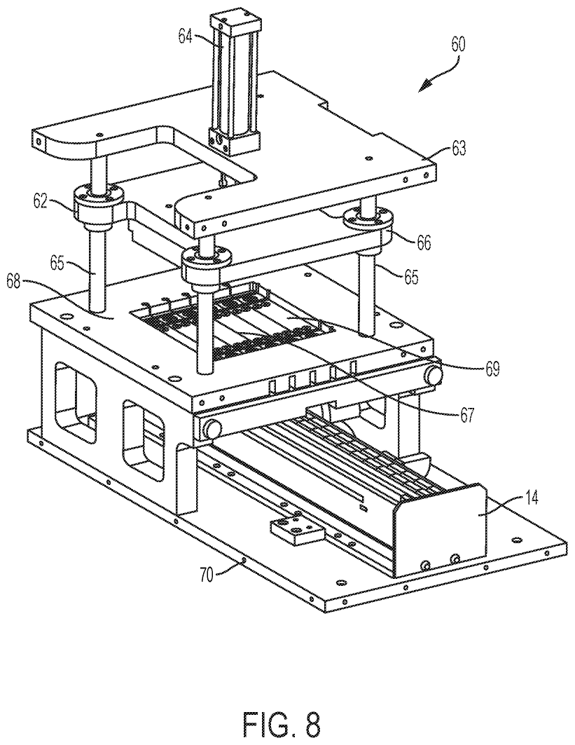

FIG. 8 is a three-dimensional perspective view of a cutting device 60, according to another embodiment of the present disclosure. In this embodiment, for example, a pressure plate 62 is used instead of the robotic arm of the prior embodiment to apply pressure on the sheet of film while cutting the film. As depicted in FIG. 8, the cutting device 60 is provided with a pressure plate 62. The pressure plate 62 can be used, for example, to apply a pressure on the film to hold the film. In an embodiment, a pneumatic mechanism 64, such as an air cylinder, can be used to move the pressure plate 62. In an embodiment, the pneumatic mechanism 64 is mounted to support plate 63 which is mounted to a plurality of support rods 65. In an embodiment, a pneumatic cylinder of the pneumatic mechanism 64 is mounted the support plate 63 while a pneumatic rod of the pneumatic mechanism 64 is connected to the pressure plate 62 to move the pressure plate 62. In an embodiment, pressure plate 62 is connected to the output shaft of the pneumatic mechanism 64. In an embodiment, the pneumatic mechanism 64 is configured and mounted to raise/lower the pressure plate 62. In another embodiment, instead of the pneumatic mechanism 64, a linear motor can be used to move the pressure plate 62. The pressure plate 62 can be mounted on a plurality of rods 65 to guide the pressure plate 62 during its movement. Accordingly, the pressure plate 62 can include linear bearings 66 at the interface with the rods 65 to allow the pressure plate 62 to slide on the rods 65. The cutting device 60 also includes a film support plate 68 (e.g., a tray) located beneath the pressure plate 62. The film support plate 68 defines a cavity 69 configured to receive the film sample to be cut. The film support plate 68 includes a plurality of slots 67 through which a plurality of blades (not shown in this figure) extend to enable cutting of the film. For example, as shown, the slots 67 can extend through the cavity 69. The cutting device 60 also comprises a linear actuator 14, such as a linear motor, to drive the plurality of blades. The linear actuator 14 is mounted on base plate 70. In an embodiment, as shown in FIG. 8, the base plate 70 also provides support to the film support plate 68, the rods 65, the pressure plate 62, and the pneumatic mechanism 64 mounted on the support plate 63.

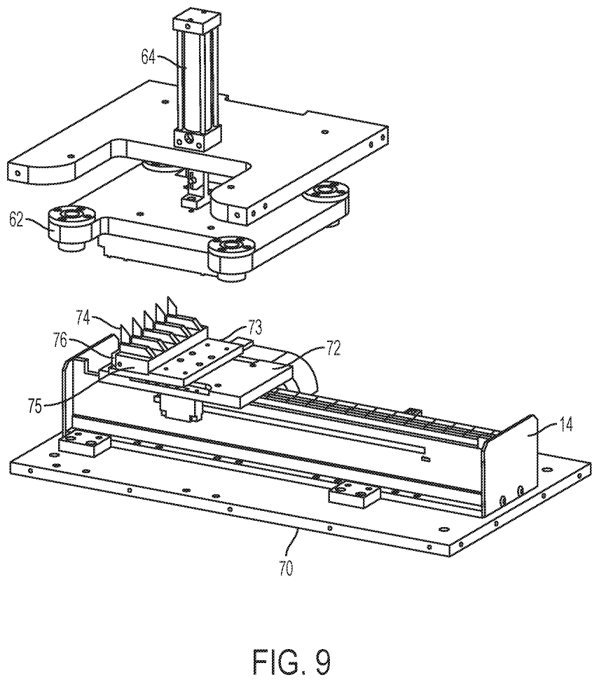

FIG. 9 is an exploded perspective view of parts of the cutting device 60 showing a plurality of the blades 74 mounted to the linear actuator 14, according to an embodiment of the present disclosure. In this embodiment, the plurality of blades 74 are mounted to a moveable plate 72 through adjustable plate 73. The moveable plate 72, similar to the moveable plate 52 described in the above paragraphs, is attached or coupled to the output of the linear actuator 14. The moveable plate 72 is moved by the linear actuator 14. The plurality of blades 74 can be mounted to the moveable plate 72 in a similar fashion as described in the above paragraphs with respect to FIGS. 5 and 6. A blade mounting bracket 75 is mounted to the adjustable plate 73 which is mounted to the moveable plate 72. The adjustable plate 73 is configured to adjust the position of the blade mounting bracket 75 relative to moveable plate 72. For example, the blade mounting bracket 75 can be mounted to the position adjustable plate 73 and the position adjustable plate 73 can be mounted to the moveable plate 72 so as to allow the blade mounting bracket 75 and thus the blades 74 to extend forward from an edge of the linear actuator 14. The blade mounting bracket 75 is configured and arranged to receive the blades 74. A securing bracket 76 is attached to blade mounting bracket 75 to secure the blades 74 thereto. When the moveable plate 72 is driven by the linear actuator 14, the blades 74 move along with the moveable plate 72. In FIG. 9, the film support plate 68 and rods 65 are omitted so as to show the blades 74 located underneath the film support plate 68.

In an embodiment, five cutting blades 74 are mounted to the moveable plate 72. The five blades 74 are separated apart equidistantly so as to cut six strips with substantially equal width, for example, 6″ (15.24 cm) long strips with a width of 1″ (2.54 cm). However, any number of blades 74 and spacings can be provided depending on a desired number of strips or a desired width for each strip.

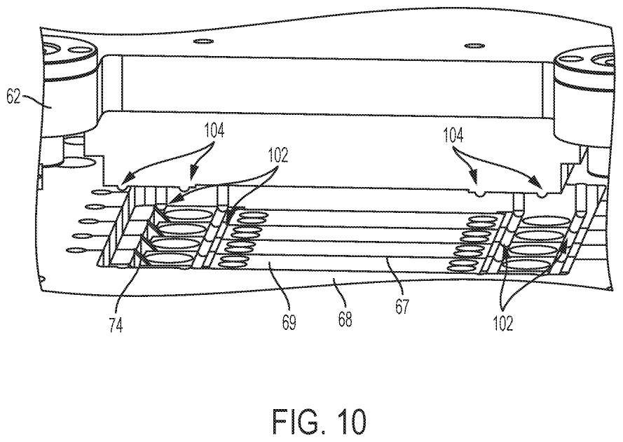

FIG. 10 is a three-dimensional perspective view of the cutting device showing a close-up of the pressure plate 62 and the film support plate 68, according to an embodiment of the present disclosure. As shown in FIG. 10, film support plate 68 includes a plurality of grooves 102 that traverse the slots 67. For example, the film support plate 68 can include first and second pairs of grooves 102. As shown in FIG. 10, the pressure plate 62 includes a plurality of tongues 104. The plurality of tongues 104 are configured to mate with the plurality of grooves 102 so as to hold a film therebetween inside the cavity 67 of the film support plate 68. The plurality of grooves 102 and tongues 104 are provided so as to hold the film taut. Without maintaining a retention force on the film, the film would roll up or otherwise deform as the blades 74 make contact therewith.

Still referring to FIG. 10, in an embodiment, as the pressure plate 62 moves downward the tongues 104 move downward to mate with the grooves 102 provided in the film support plate 68. As a result, the tongues 104 push the film downward into the respective mating grooves 102, with the effect that the film becomes taut in the regions spanning between mating tongues 104 and grooves 102. In the embodiments shown in FIGS. 1, 2, 3A and 3B, the blade traverses the film during cutting between and parallel to the mating tongue and groove arrangement. In the embodiment shown in FIG. 10, the blades 74 traverse the film perpendicular to the tongue and groove arrangement. Regardless of the selected configuration, the mating tongues and grooves serve to hold the film taut during the cutting process. In an embodiment, the pneumatic mechanism 64 moves the pressure plate 62 to apply force or pressure on the film resting in the cavity 67 of the film support plate 68. Although FIG. 10 shows the grooves 102 being provided in the film support plate 68 and the tongues being provided on the pressure plate 62, it is also contemplated that the grooves 102 can be provided on the pressure plate 62 and the tongues can be provided on the film support plate 68. According to an embodiment, the dimensions (e.g., radius) of the grooves 102 are not the same as the dimensions (e.g., radius) of the tongues 104. Instead, the tongues 104 can have a slightly smaller radius than the grooves 102, so as to reserve space for the film to be inserted therebetween. The difference in size between the grooves 102 and the tongues 104 can be selected by the user depending, for example, on the thickness of the film to be cut. For example, the size of the grooves 102 and tongues 104 can be selected to accommodate a range of thicknesses of film, e.g., between 0.5 mil (12.7 micrometer) to 10 mil (254 micrometer). Although the grooves 102 and tongues 104 are shown having a semicircular cross-section, the grooves 102 and tongues 104 can also have other mating or substantially mating configurations, such as a polygonal cross-section or other rounded cross-section.

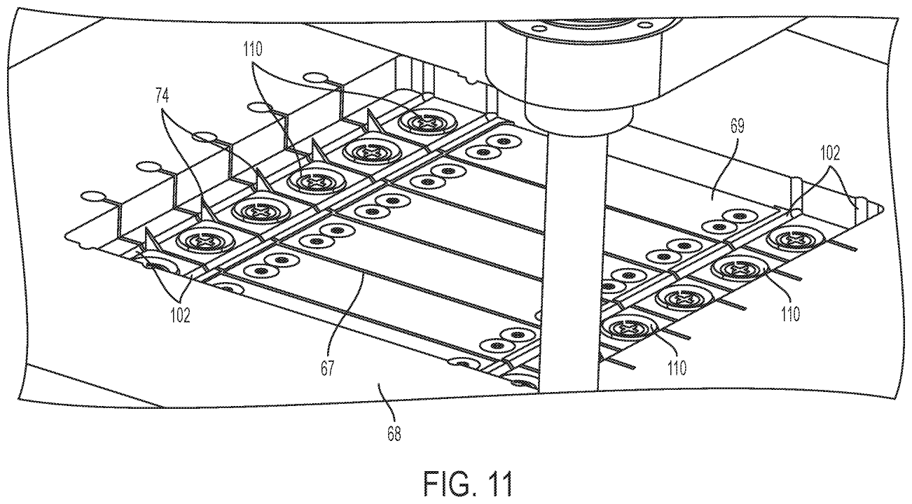

FIG. 11 is a three-dimensional perspective view of a portion of the cutting device 60 showing details of film support plate 68, according to an embodiment of the present disclosure. As shown in FIG. 11, the film support plate 68 is provided with a plurality of slots 67 to allow the blades 74 to run therethrough. Also shown in FIG. 11 are the first and second pairs of spaced apart grooves 102, which are located towards the extremities of cavity 69 in the film support plate 68. In an embodiment, the film support plate 68 may also include a plurality vacuum cups 110 or other suction deices provided inside the cavity 69 of the film support plate 68. For example, as shown, the vacuum cups 110 can be located between each pair of spaced apart grooves 102. However, other configurations are possible.

The vacuum cups 110 are configured to hold the cut film specimens optionally before, during and/or after the film sample is cut and the pressure plate 62 is decoupled from the film support plate 68. Stickier films, and films that have built up static electricity, may sometimes lift off from the film support plate 68 as the pressure plate 62 is raised and decoupled from the film support plate 68. In an embodiment, the vacuum cups 110 are not actuated during cutting of the film sample, but are actuated after cutting is complete to hold cut specimens during decoupling of the pressure plate 62 from the film support plate 68. In an embodiment, the vacuum cups 110 are 15 mm wide, and are configured for handling thin films. In an embodiment, the vacuum cups 110 are provided by EMI Plastics Equipment.

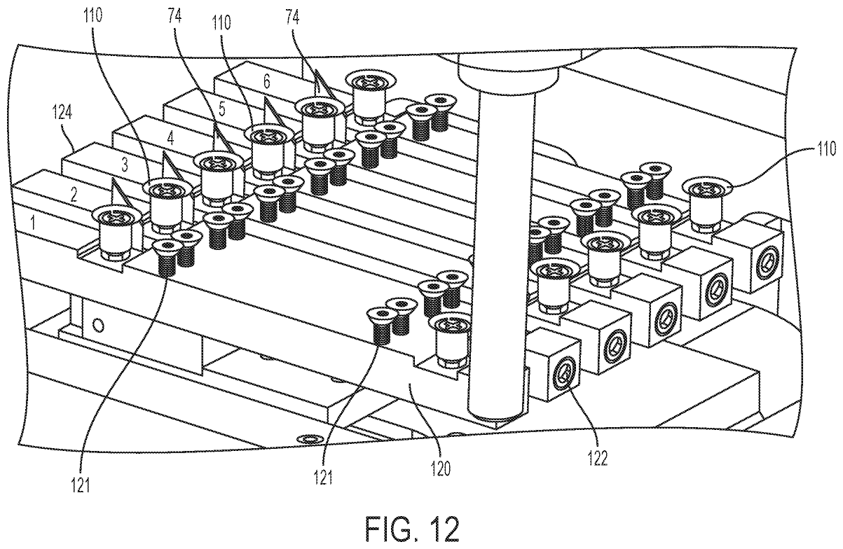

FIG. 12 is a three-dimensional perspective view of a portion of the cutting device 60 showing details of the vacuum cups 110 in the cavity 69 of film support plate 68, according to an embodiment of the present disclosure. In FIG. 12, the film support plate 68 is removed and not shown to show details of the blades 74 and vacuum cups 110 and associated vacuum supply channels. According to the embodiment shown, the vacuum cups 110 are attached to bars 120, such as long rectangular bars. Two vacuum cups 110 can be attached to each bar 120, however, other quantities are possible. A channel extends lengthwise through each bar 120 for supplying vacuum to the vacuum cups 110 attached to each bar 120. The channel is plugged on one end by plug 122, and the vacuum is supplied from the opposite end 124. According to this embodiment, each bar 120 along with a pair of vacuum cups 110 forms an independent vacuum suction system. Locating the vacuum cups 110 on separate bars 120 allows for each of the plurality film segments to be released in any order, assuming there are six independent vacuum supplies. In an embodiment, two independent vacuum supplies are attached to two pairs of alternating strips (e.g., labeled 1, 3, 5 and 2, 4, 6, respectively). A robotic gripper or pressure plate 62 can pick the alternating strips (1, 3, 5) or (2, 4, 6) simultaneously. However, according to alternative embodiments, a robot gripper or pressure plate 62 can be configured to pick a single strip at a time, or to pick all strips simultaneously. As shown in FIG. 12, the suction cups 110 and fasteners (e.g., screws) 121 are sticking up from the bars 120 as the film support plate 68 is removed and not shown. The fasteners (e.g., screws) 121 are used to attach the film support plate 68 to the bars 120. When the film support plate 68 is attached to the bars 120, the fasteners 121 and the suction cups 110 would be substantially flush with the film support plate 68 and the blades 74 would extend through the plurality of slots 67, as depicted in FIG. 11.

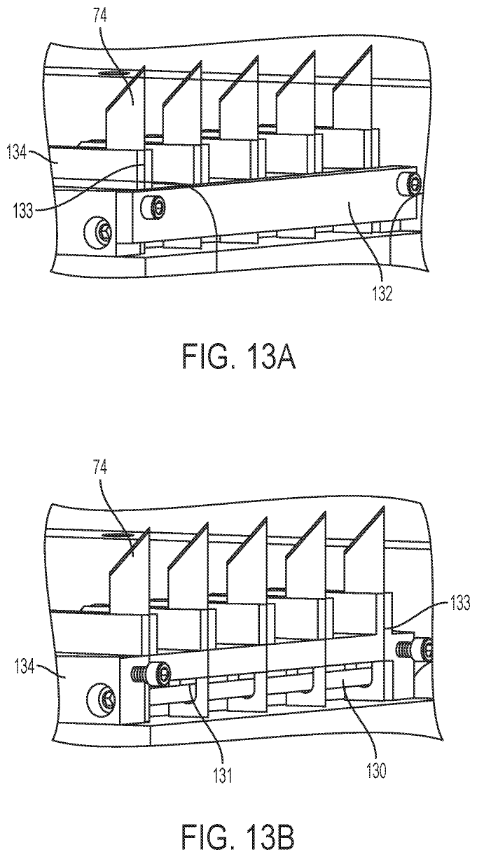

FIGS. 13A and 13B are three-dimensional perspective views showing the positioning and securing of the plurality of blades to the linear actuator, according to an embodiment of the present disclosure. As shown in FIG. 13B, the blades 74 are held secure using a bolt 130 that transverses through the slots 131 of the blades 74. The blades 74 are inserted in slots 133 provided in the blade support bracket 134. Referring to FIG. 13A, a bar 132 is used to prevent the blades 74 from tilting during cutting. The bar 132 covers the blade holding bolt 130. To expose the blade holding bolt 130, the bar 132 is removed first from the blade support bracket 134. To remove the blades 74, an operator can unscrew the bolt 130, remove the bolt 130, then use a set of tweezers to pull the blades 74 upward and out of the slots 133 through which the blades are inserted. According to an embodiment, the slots 133 containing the blades 74 are designed to be a few thousandths of an inch (few tens to hundreds of micrometers) wider than each blade 74, so the blades 74 slide easily out of and back into the slots 133.

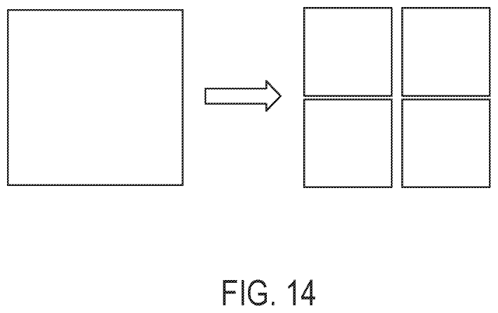

FIG. 14 shows schematically a configuration in which a square-shaped film sample is cut into a plurality of square-shaped specimens, according to an embodiment of the present disclosure. In this embodiment, the cutting device makes cuts that are transverse, or perpendicular to, each other. To obtain this configuration, the cutting device can include two linear actuators that actuate perpendicular to one another. Each linear actuator can drive at least one blade. According to an embodiment, after the first blade has finished its cut and has moved out of the way of the second blade, the second blade cuts the film at an angle to the first cut, e.g., 90 degrees.

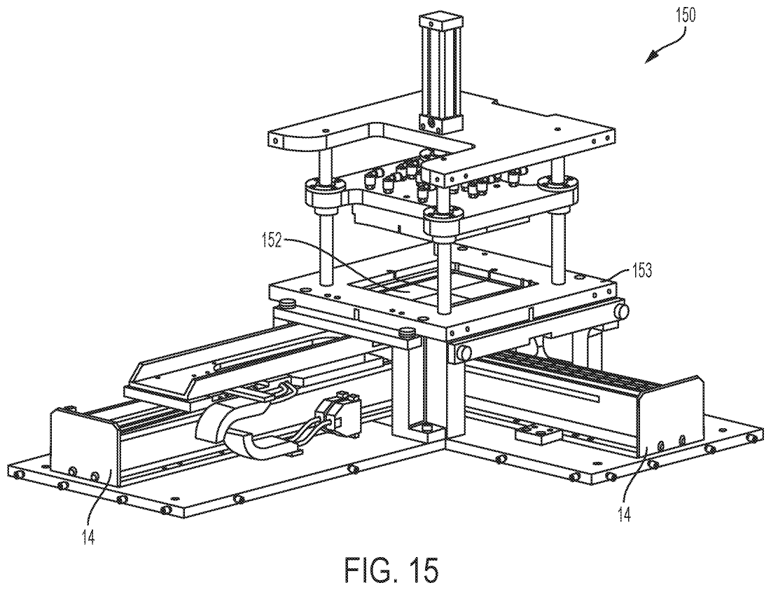

FIG. 15 is a three-dimensional perspective view of a cutting device, according to another embodiment of the present disclosure. The cutting device 150 shown in FIG. 15 is similar in many aspects to the cutting device 60 shown in FIG. 8. Therefore, a description of similar features is not repeated. It must be noted, however, that a difference between the cutting device 60 and the cutting device 150 is that the cutting device 150 uses two linear actuators 14, such as linear motors. In an embodiment, the linear actuators 14 are arranged perpendicular to each other so that the blades (not shown in this figure) driven by the two linear actuators 14 cut the film sample 152 in two directions angled with respect to each other (e.g., perpendicular), as shown in FIG. 15.

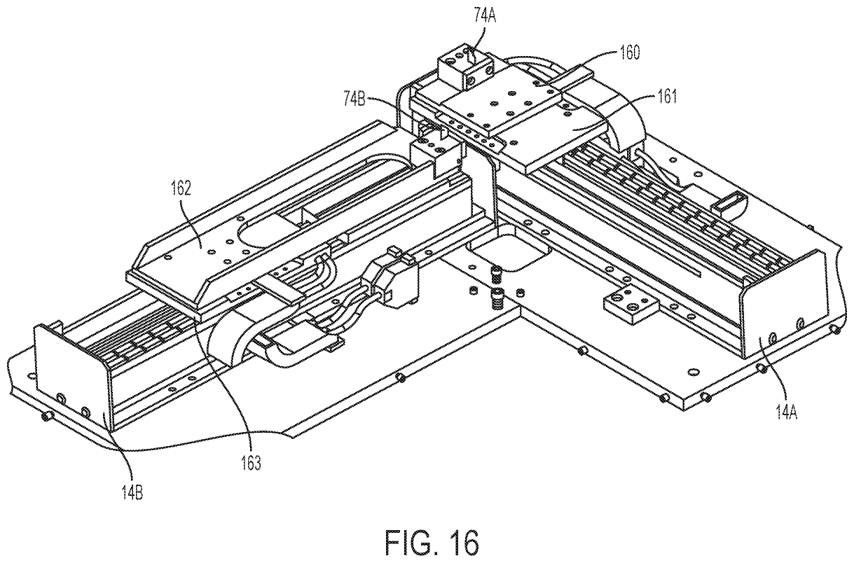

FIG. 16 is a three-dimensional perspective view of an arrangement of two linear actuators having two blades mounted thereon, according to an embodiment of the present disclosure. In FIG. 16, some components of the cutting device 150 are removed to reveal the mounted blades 74A and 74B and their mounting on the two linear actuators 14A and 14B. As shown in FIG. 16, a first blade 74A is mounted on a blade holder plate 160 that is connected to a moveable plate 161 of the first linear actuator 14A, and a second blade 74B is mounted on a longer blade holder plate 162 that is connected to a moveable plate 163 of a second linear actuator 14B. Because the moveable plate 163 can only travel to an edge of the second linear actuator 14B, the blade holder plate 162 is mounted to the moveable plate 163 so as to extend farther than the edge of the second linear actuator 14B so as to allow the blade 74B to cover a width of the first linear actuator 14A. In this way, the film can be cut in a first direction by the first blade 74A mounted on the blade holder plate 160 and also cut in a second direction by the second blade 74B mounted on the blade holder plate 162. By providing the blade holder plate 162 with an extended length, the film can be cut in the second direction by traversing the second blade 74B from one side to an opposite side of the film sample.

The second linear actuator 14B is configured to move the second blade holder plate 162 relative to the film support plate 153 (shown in FIG. 15). The cutting blade 74B is mounted to the second blade holder plate 162 for movement therewith. The second linear actuator 14B thus moves the second blade holder plate 162 relative to the film support plate 153 to cut the film sample on the film support plate 153. According to an embodiment, the blade 74A held by the first blade holder plate 160 is arranged to cut the film in a first direction, and the blade 74B held by the second blade holder plate 162 is arranged to cut the film in a second direction perpendicular to the first direction.

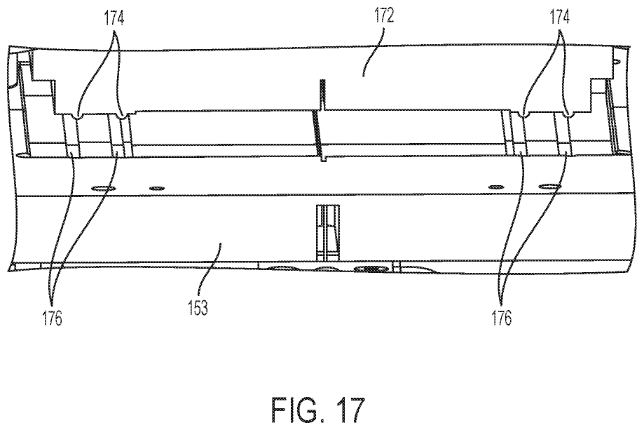

FIG. 17 is a three-dimensional perspective view of the film support plate 153 having a plurality of grooves 176, and a pressure plate 172 having a corresponding plurality of tongues 174, according to an embodiment of the present disclosure. The pressure plate 172 can be used, for example, to apply a pressure on the film to hold the film sample to be cut. The pressure plate 172 includes a plurality of tongues 174. The plurality of tongues 174 are configured to mate with the plurality of grooves 176 provided on the film support plate 153, so as to hold a film sample taut. According to this embodiment, the film sample is cut parallel to the tongues 174 and grooves 176 by one blade, and is cut perpendicular to the tongues 174 and grooves 176 by the other blade. The tongues 174 and grooves 176 can be configured and can operate in a similar fashion to the tongues and grooves describes in previous embodiments.

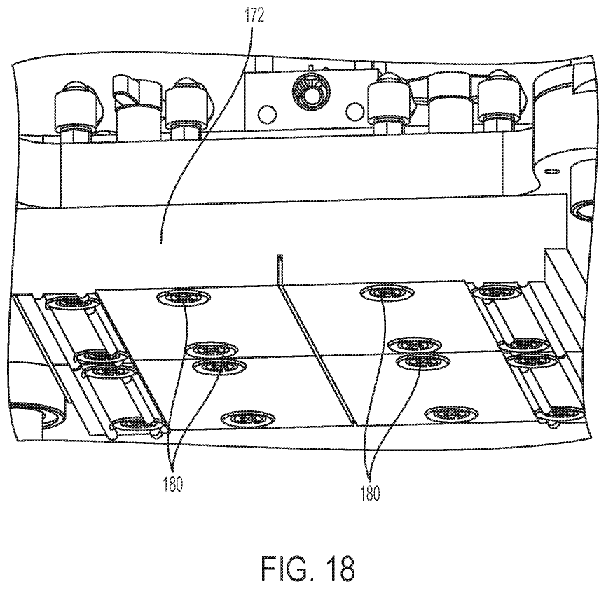

FIG. 18 is a three-dimensional perspective view of the pressure plate 172, according to an embodiment of the present disclosure. In an embodiment, instead of providing the vacuum suction cups on the film support plate 153, the vacuum cups can be provided on the pressure plate 172. In an embodiment, as shown in FIG. 18, the pressure plate 172 includes a plurality (e.g., 16) of vacuum cups 180. The plurality of vacuum cups 180 can be arranged to locate a vacuum cup 180 at the corners of each quadrant of the film sample. For example, if 16 vacuum cups 180 are provided in the pressure plate 172 and the film sample is a 6″ (15.24 cm) square film, four vacuum cups can be provided for each cut 3″ (7.62 cm) square film specimen. After cutting, the vacuum is turned on in each vacuum cup 180 and each of the quadrants of the film specimen can be picked off the film support plate 153. The plurality of vacuum cups 180 are configured to hold cut film specimens in position after the pressure plate 172 decouples from the film support plate 153.

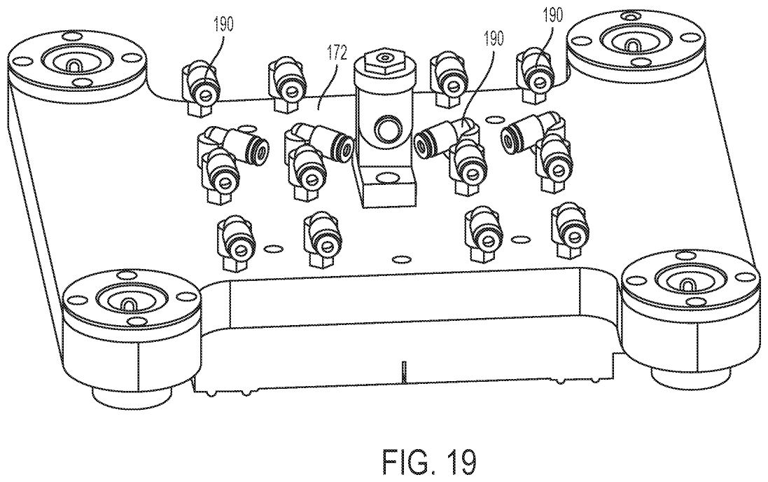

FIG. 19 is a three-dimensional perspective view of the pressure plate 172 showing a plurality of elbow fittings 190 for providing vacuum to the vacuum cups, according to an embodiment of the present disclosure. In an embodiment, vacuum is supplied individually to each vacuum cup through elbow fittings 190 mounted to the pressure plate 172. Vacuum can be applied to a set of fittings 190, for example one vacuum source could supply four fittings to lift one of the cut film specimens, e.g., 3″ (7.62 cm) squares. In this case, one vacuum source is provided to each set of vacuum cup for holding each quadrant separately. In another embodiment, the vacuum source supplies vacuum to multiple fittings simultaneously.

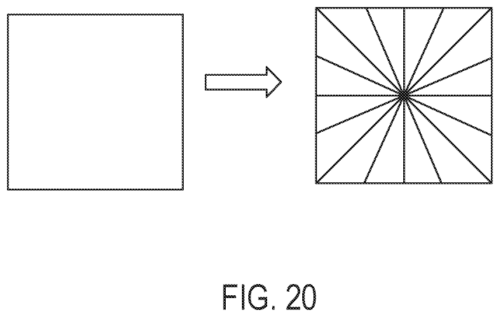

FIG. 20 depicts a cutting configuration, according to yet another embodiment of the present disclosure. In this configuration, a single linear slide with a cutting blade can be mounted onto a rotary stage. The film support plate can have several channels cut into it at angles other than 90 degrees (for example, every 45 degrees). According to this embodiment, many pie-shaped film specimens can be cut, as shown for example in FIG. 20. In yet other embodiments, the present cutting device can be configured to cut a film sample in any desired configuration of straight edged cuts such as triangles or diamond shapes.

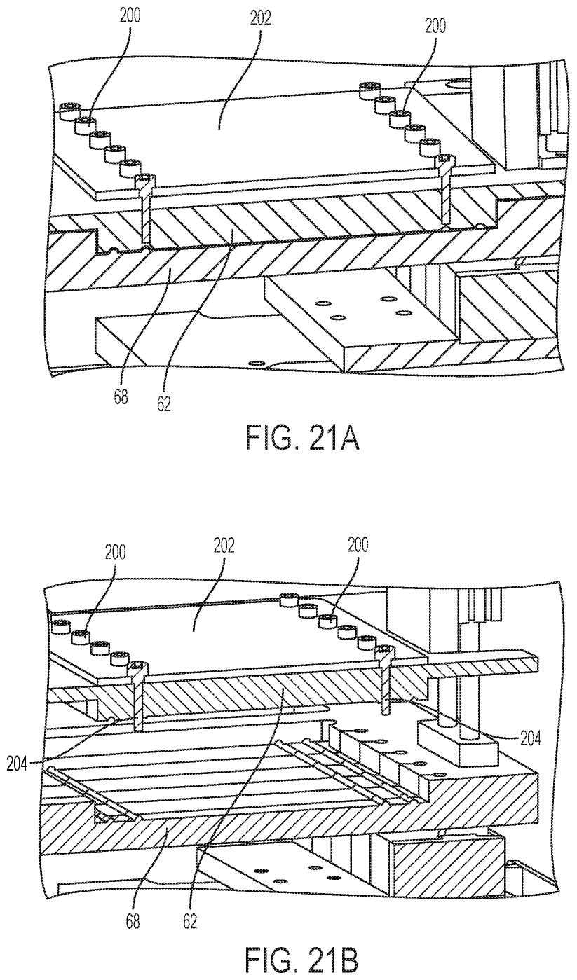

FIGS. 21A and 21B are three-dimensional perspective views showing a film support plate and a pressure plate in mated and unmated positions, respectively, according to an embodiment of the present disclosure. In an embodiment, a plurality of screws 200 are provided on a plate 202 that is placed on top of the pressure plate 62. The plurality of screws 200 are provided to insure that the film of material remains in position in the film support plate 68 when pressure plate 62 retracts from the film support plate 68. For example, when the pneumatic is actuated and the film support plate 68 and pressure plate 62 are brought together, contact between the distal ends 204 of the screws 200 and the tongues on plate 68 cause the screws 200 to slide upward within the channels in which they are located, as shown in FIG. 21A. This causes the plate 202 secured to the proximal end of the screws 200 to rise upward from the pressure plate 62. After the film sample is cut, the pressure plate 62 is retracted from the film support plate 68. Under the force of gravity acting on the plate 202, the screws 200 lower to extend the distal portion 204 outside the channels in pressure plate 202 to push the film specimens back down into the film support plate 68. In an embodiment, the screws 200 extend out of the channel by about ⅛ of an inch (0.317 cm) when plate 202 is against pressure plate 62, however, other lengths are possible.

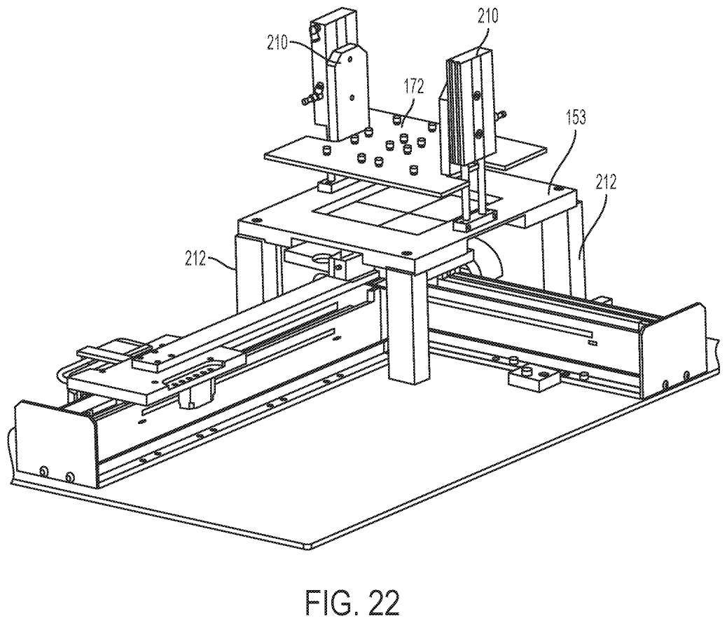

FIG. 22 is a three-dimensional perspective view of a cutting device, according to another embodiment of the present disclosure. In this embodiment, for example, the pressure plate 172 is actuated by two pneumatic mechanisms 210. The pneumatic mechanisms 210 are configured and mounted to raise/lower the pressure plate 172. In an embodiment, the pneumatic mechanisms 210 are mounted to support plate 153. The support plate 153 is mounted to a plurality of support posts 212. In an embodiment, the pneumatic mechanisms 210 are placed at opposing extremities of the pressure plate 172. A fixed part of each pneumatic mechanism 210 is mounted to the film support plate 153 while a movable part of each pneumatic mechanism 210 is coupled to the pressure plate 172. Although two pneumatic mechanisms 210 are shown being used to actuate the pressure plate 172, more than two pneumatic mechanisms can also be used.

According to an embodiment, the linear actuator 14 is selected so as to be able to cut various thicknesses of film. In an embodiment, the linear actuator 14 is driven to achieve a cutting velocity of at least 0.1 meters per second. The cutting velocity will depend on the physical properties of the film being cut, for example, a film with higher elasticity will require a relatively faster cutting speed than a film with lower elasticity. In an embodiment, the linear actuator 14 is configured to move the moveable plate holding the cutting blade at a velocity of at least 2 m/s (for example, between 2 m/s and 6 m/s) so as to cut the film and to provide cut pieces of film with a smooth cut edges (e.g., lacking jagged edges). In an embodiment, the linear actuator 14 is configured to move the moveable plate holding the cutting blade at a velocity of up to 5 m/s. In addition to achieving the desired speed (e.g., 2 m/s), it is also desirable that the linear actuator 14 have an acceleration sufficient to achieve a constant velocity during cutting, for example, the acceleration will need to be sufficient to move the blade from a stop to the desired velocity prior to the blade contacting the film. The higher the attainable acceleration is, the lesser a distance required to bring the cutting blade to its desired cutting speed (e.g., 2 m/s). This feature can reduce the overall dimensions of the linear actuator 14 and thus of the cutting device as whole.

In another embodiment, the linear actuator 14 can comprise a pneumatic piston device, or a resilient member device such as a spring-loaded device to drive the blade 16. According to yet another embodiment, the linear actuator can comprise a weight attached to a slide. The blade can be attached to the slide, and the weight can be dropped to move the slide and blade. One of ordinary skill in the art will appreciate based on this disclosure than any number of different types of linear actuators can be used to drive the blade(s). However, screw-driven devices and rotary motors may not provide sufficient speed to the blade(s) to adequately perform the cuts.

In some embodiments, the present cutting device can have a foot print that is not much larger than a size of the film of material the device is designed to cut. According to embodiments of the present disclosure, the present cutting device can cut various materials including polymeric films such as plastics and non-polymeric films such as fabric, paper, metal, or composite materials.

1. A cutting device for cutting a film of material, the device comprising:
a film support plate;
a pressure plate configured to move relative to the film support plate to hold the film of material on the film support plate;
one or more blades; and
a linear actuator configured to move the one or more blades relative to the film support plate to cut the film of material held on the film support plate.

2. The cutting device according to claim 1, wherein the linear actuator comprises a linear motor configured to move the one or more blades through the film of material with a velocity of at least 0.1 m/s.

3. The cutting device according to claim 1, wherein one of the film support plate and the pressure plate comprises a plurality of tongues, and the other of the film support plate and the pressure plate comprises a plurality of grooves, wherein the plurality of tongues are configured to mate with the plurality of grooves to hold the film of material therebetween.

4. The cutting device according to claim 1, wherein the film support plate defines one or more slots, wherein each of the one or more blades extends through one of the one or more slots to cut the film of material.

5. The cutting device according to claim 1, wherein the film support plate comprises a plurality of vacuum cups, the plurality of vacuum cups being configured to hold cut portions of the film of material.

6. The cutting device according to claim 1, wherein the pressure plate comprises a plurality of vacuum cups, the plurality of vacuum cups being configured to hold cut portions of the film of material.

7. The cutting device according to claim 6, further comprising a vacuum system configured to apply vacuum to each vacuum cup.

8. The cutting device according to claim 1, wherein the linear actuator is mounted onto a rotary stage so as to cut the film of material held on the film support plate in a plurality of directions.

9. The cutting device according to claim 1, further comprising:
one or more second blades; and
a second linear actuator configured to move the one or more second blades relative to the film support plate to cut the film of material on the film support plate.

10. The cutting device according to claim 9, wherein the first linear actuator is configured to move the one or more blades in a first direction, and the second linear actuator is configured to move the one or more second blades in a second direction that is at an angle between 45 and 135 degrees with respect to the first direction.

11. The cutting device according to claim 1, further comprising a robotic arm, wherein the pressure plate is connected to the robotic arm, and the robotic arm is configured and arranged to move the pressure plate towards the film support plate to apply pressure on the film of material.

12. A method for cutting a film of material, the method comprising:
placing a film of material on a film support plate;
moving a pressure plate relative to the film support plate to hold the film of material on the film support plate; and
moving one or more blades relative to the film support plate with a linear actuator to cut the film of material held on the film support plate.

13. The method according to claim 12, further comprising holding the film of material taut between the film support plate and pressure plate using a plurality of tongues and plurality of grooves, the plurality of tongues being configured to mate with the plurality of grooves to hold the film of material therebetween.

14. The method according to claim 12, further comprising holding cut portions of the film of material with a plurality of vacuum cups provided on one of the film support plate and the pressure plate.

15. The method according to claim 12, further comprising moving one or more second blades relative to the film support plate with a second linear actuator to cut the film of material on the film support plate.
